(19) United States
(12) Patent Application Publication
(10) Pub. No.: US 2002/0004849 A1
(43) Pub. Date: Jan. 10, 2002

(54) Fault tolerant internet communications system

(75) Inventors: Daryl Eigen, Boca Raton, FL (US); Tomas Beinaravicius, Kaunas (LT); Gediminas Bukauskas, Kaunas (LT); Darius Ivanauskas, Kaunas (LT); Liutauras Lipavicius, Kaunas district (rajonas) (LT); Sarunas Misius, Kaunas (LT); Giedrius Vilpisauskas, Kaunas (LT)

Correspondence Address: Santangelo Law Offices, P.C., Thrid Floor, 125 South Howes, Fort Collins, CO, 80521, US

(73) Assignee: eLink Business, Boca Raton, FL (US)

(21) Appl. No.: 09/874,237

(22) Filed: Jun. 5, 2001

Related U.S. Application Data
(60) Provisional application No. 60/213,151, filed on Jun. 22, 2000.

(51) Int. Cl. G06F 9/00; G06F 9/54; G06F 15/163

(52) U.S. Cl. 709/310

(57) ABSTRACT

A fault tolerant Internet communications system provides highly reliable e-commerce and server/router functions through scaled down operating system functions provided as a disk on a chip system. It may facilitate initial configuration and installation even through a disparate operating system element through remotely accessible and Internet configurable designs. Immediate shifting to the scaled down operating system can occur to permit re-routing to a redundant or other data server element or even basic informational functions to avoid total lack of communication to users.

This application claims the benefit of application 60/213,151 filed on Jun. 22, 2000. The contents of that application are hereby incorporated by reference.

### BACKGROUND OF THE INVENTION

Generally, this invention relates to a method and a means of conducting communications over the Internet including e-mail, dissemination of information found in Web pages and the purchase and sale transactions commonly known as e-commerce. Specifically, the invention focuses on providing ultra-reliable hardware and software which is fault tolerant. More specifically, the invention allows for the integration of the router functions into the device which provides the information server functions. The resulting single device is also remotely configurable via either the Internet through an encrypted link or through an analog modem connection.

As traffic over the Internet has evolved, it has evolved almost universally around a model consisting of a Web access router, a data server and an electronic communications link between the two. See Figure No. 1. With this conventional configuration, there is a need for the user to have knowledge and expertise in configuring and operating the component which perform some routing functions, namely, the router element. Similarly, the user needs to have knowledge and expertise on configuring and operating the component(s) which perform some data serving functions, namely, the data server element. Technology involved in each is unique and this results in a barrier to entry into the world of e-commerce.

What this means for users of the conventional configuration is that resources need to be located and devoted to the mastery of router and server technologies. This is often difficult because the router represents technology from the world of communications, while the server represents technology relating to computers. For users, this usually means that a sufficiently high level of Internet or e-commerce knowledge must be available before it is feasible to implement a system based on the conventional configuration. In short, using the conventional configuration means that certain economies of scale may need to be reached before conventional configurations become economically viable. This creates barriers to entry for small- and medium-sized businesses seeking to make their first foray into Internet business or e-commerce.

The reliability of a conventional system is the product of the reliability of each of its components. By having three components (the router, the server and the communications link between the two), the overall reliability of the system is the product of the reliability of each component. For example, if the router element, data server element, and communications link are each 90 percent reliable, the overall reliability of the three component conventional system will be only approximately 73 percent. The weakest link in the conventional system may be the server. This may be due, in part, to the particular operating system being used and that the server requires a hard drive for data storage. An operating system which is unstable and prone to crashes renders the entire conventional system unstable.

Similarly, if a hardware related failure occurs—such as the hard drive in the server crashes—this will render the entire system inoperable as well. This is due to the fact that the operating system is loaded onto the server's hardware and data needs to flow from the hard drive to random access memory and back during normal functions. If the hard drive malfunctions or otherwise ceases to function, then the entire server will cease to function.

If a server ceases to function and that server is employed in Internet business or e-commerce, then the flow of data to and from the Web site located on that server will be disrupted. The direct consequence of this will be that the value associated with that data stream will be lost for the period of the disruption. For heavily trafficked Web sites, the losses could be substantial and a downtime of only an hour could be significant.

In order to overcome the potential losses associated with having a conventional system malfunction, users of the conventional system often have to employ a redundant array of inexpensive disks, commonly known as “RAID” technology. Others have switched operating systems and have begun using Linux, an operating system noted for its robustness and stability, but also noted for its being difficult to configure.

Perhaps the most pressing problem facing companies involved in Internet based business, businesses, or e-commerce is reliability. As the portion of the world's economy that is represented by e-commerce continues to grow and expand, more and more businesses will find themselves getting involved in this type of commerce. The level or degree of involvement may range from having Web pages or web page advertising of a specific business to having a virtual Private network where numerous and substantial transactions are taking place around the clock at locations spread throughout the world. Since the e-commerce or Internet based business segment will represent an ever-increasing amount of the overall business revenue, merchants involved in such commerce may be expected to require that their Internet or e-commerce systems be as reliable as, say, a conventional cash register.

A second most pressing problem that companies are facing in the electronic age is the cost and complexities associated with initially configuring and maintaining their e-commerce systems. This problem manifests itself through the specialized knowledge required to initially configure the router and server systems and the resources needed to keep the conventional system on line by responding to and overcoming system malfunctions.

Users of the conventional configuration most likely have to configure and maintain the router and the router-related technology. This represents the communications leg of an e-commerce solution. Though the communications technology has proven itself to be fairly reliable, it nevertheless represents a component with its own fault rates.

The server components found in the conventional configuration represent the computer or data processing component. The technology associated with this component has proven to be considerably less reliable than the communications component. Fault rates associated with the server technology have proven to be quite high.

Because of the high fault rates associated with servers, considerable efforts have been invested in overcoming this lack of reliability. Examples of these efforts include redundant systems, fault monitoring systems and round-the-clock maintenance and support.

Current efforts are directed toward devising high reliability e-commerce systems. The systems are being developed to provide high reliability, low fault rates and ease of the implementation and ongoing maintenance.

### SUMMARY OF THE INVENTION

The present invention may include a variety of aspects which address many of the problems associated with the conventional configuration. The various aspects of the invention may allow for reliable, economical configuration and operation of the e-commerce router and server functions.

One aspect of the present invention may be the incorporation of a scaled-down version of the basic operating system on a computer chipset. A reduced functionality operating system element, including but not limited to such a chipset, may be provided. The complete operating system is traditionally located on the hard drive and during normal operation, operating system functions move back and forth from the hard drive's permanent memory or storage memory to random access memory. In the event of a malfunction in the hard drive in a system using the conventional configuration, all server functions could cease. The present invention can avoid this result and can incorporate a scaled-down operating system saved on a flash memory-type chip set. The scaled-down operating system may even be designed exclusively for the flash memory chipset or for some flash memory element. The incorporation of the scaled down operating system may have reduced functionality. It may only allow for continued router and limited server functions in the event of a hard drive malfunction. In the event the hard drive has malfunctioned, conventional operation is often no longer possible because the transfer of data from the hard drive to random access memory is disrupted. The incorporation of the scaled-down operating system can allow for exchange of data from the flash memory chipset to random access memory. The incorporation of a second operating system on a flash memory element may allow basic functions of e-commerce to continue. This may include continued functioning of the Web pages, e-mail server functions and local area network functions. Though in some embodiments complete functionality may not continue in the event of a hard drive malfunction, this aspect of such an embodiment of the present invention can allow for continued operation of at least the above-listed functions. Under the conventional configuration, in the event of a hard drive malfunction, all server functions could cease.

Incorporation of the second operating system such as on a flash memory chipset may not only present a redundant operating system element, it may address many common problems present in e-commerce under the conventional configuration. In the event of a server malfunction under the conventional configuration, all Web-site functioning will likely cease. Specifically, this means that the data contained on the Web page may no longer be available to the public over the Internet. Similarly, e-mail and other server related functions will likely cease. By providing for a second operating system on a flash memory chipset, this may allow basic e-commerce functionality to continue in the event of a hard drive malfunction. This may result in less disruption to a business employing this technology.

A second aspect of the present invention is found in the incorporation of software modules which may allow for remote administration and configuration of the server and router functions. This can provide for either or both a remote administration element and a remote configuration element. This aspect may allow the present invention to be set and reset from remote locations. The configuration modules may allow the present invention to be configured for the first time remotely. The remote configuration element models may also allow for the present invention's settings to be changed remotely.

A unique aspect of the remote configuration module or element is that they can allow remote configuration via the Internet using a common Web browser or so provide the capability through a Web browser element. Prior attempts at making devices remotely configurable have required the use of applications such as Telnet. Prior attempts often required that the remote terminal use the same operating system as the server which is being configured. The present invention's remote configuration modules may allow remote configuration to be done by any remote device with Internet access regardless of the operating system being used by the remote device. It would thus permit use of a disparate operating system element.

The advantages which remote configuration may present could be substantial. Remote configuration may allow one person to configure and manage many devices remotely. This may allow small- to medium-size businesses to overcome the costs associated with configuring the router and server. The same can be said for ongoing maintenance. Instead of requiring substantial resources for server and system administration, the small- and medium-size business can employ remote administration from outside service providers.

### BRIEF DESCRIPTION OF THE DRAWINGS

FIG. 1 shows the existing use of a separate router, firewall and Web server to provide the basics for an e-commerce site.

FIG. 2 shows the Linxera router server that combines a router, firewall and server into a highly reliable package.

FIG. 3 shows the data flow in a conventional Server. Data comes from an Ethernet LAN into the PCI bus. The relevant portions of the OS are loaded into RAM under control of the Processor. With instructions executed by the Processor, the data from the LAN are processed.

FIG. 4 shows the Linxera data flow. The data comes directly from the T1 WAN into a T1 router card. The processing is otherwise identical to the server except that the basic functions are provided by the OS on the disk on chip.

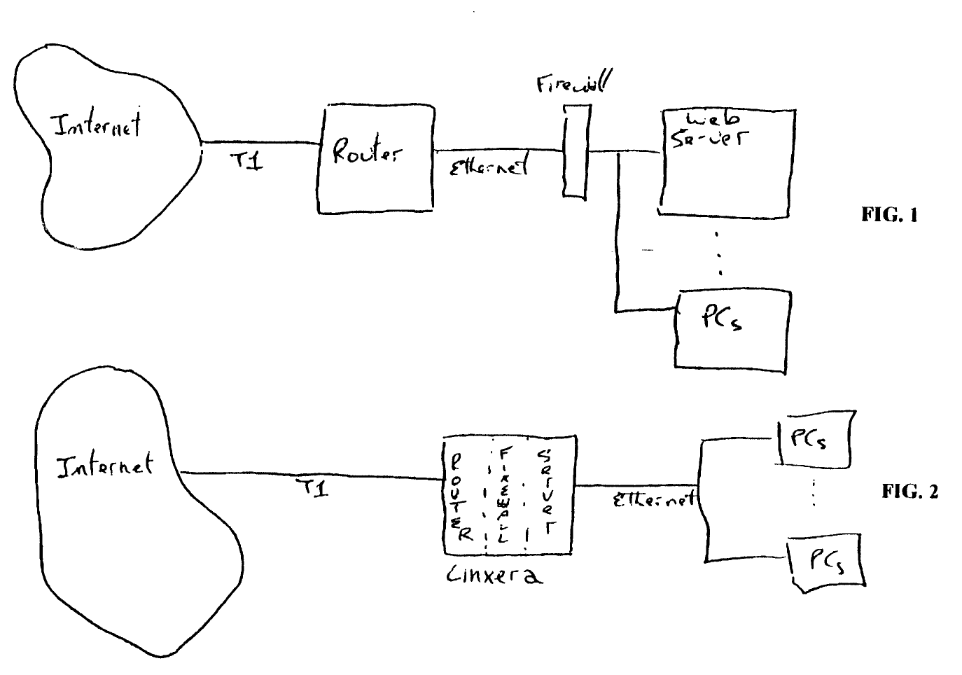

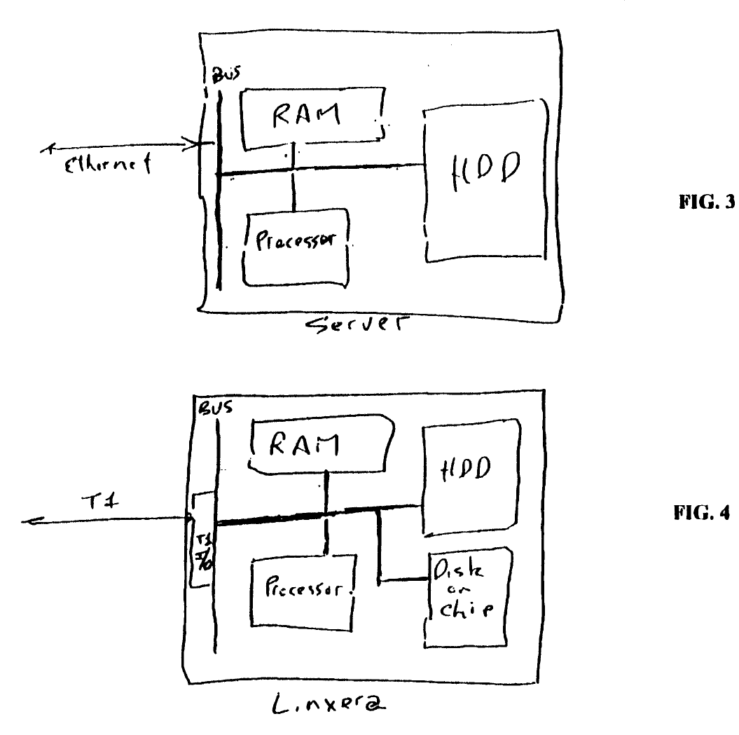

### DETAILED DESCRIPTION OF THE PREFERRED EMBODIMENTS

Generally, the present invention may utilize a single board multipurpose programmable processor or perhaps a computer as some type of independent or stand alone (e.g., not dependent on a base computational or processing system) and passive backplane which has been modified to incorporate a memory element, possibly even a flash memory chipset that is also known as a disk on chip. The revised operating system may then be installed on the flash memory chipset as part of the initial installation and configuration or perhaps preconfiguration process. During the initial and cancellation configuration process, the remote configuration and administration modules may also be loaded into the flash memory chipset.

Because a flash memory chipset or even a flash memory element may have different characteristics from the conventional hard drive, the modified or reduced functionality operating system may have to be written specially for the flash memory chipset. In one embodiment this may involve custom development of the operating system for the flash memory chipset.

The same may also be said for the remote configuration software modules. The modules may also be the result of custom software development. These may allow remote administration and facilitate use of an Internet browser in the configuration process.

The present invention is intended to include a communications element such as for use in e-commerce but may also apply beyond this area. It is intended for use in all aspects of e-commerce from the hosting of Web pages to the processing of purchases and sales over the Internet. The preferred embodiments may allow for the present invention to have enhanced reliability with reduced set up and ongoing operation costs.

The modified operating system may be placed on the flash memory chipset as a means for providing ongoing e-commerce activities in the event of a malfunction, including but not limited to a hard drive or other memory element malfunction. It may also be a means for maintaining a minimum set of functions associated with a person's e-commerce site in the event of a hard drive malfunction. Because modern day e-commerce is fundamentally different from conventional “brick and mortar” e-commerce, it can be imperative that the e-commerce merchant's presence be maintained at all times on the Internet.

To illustrate, assume that a potential customer visits an e-commerce site one day, but decides to contemplate the purchase further. The next day he decides to make the purchase, but finds that he can no longer access the web site. Because the failure of the e-commerce site is in many respects an “all or nothing” proposition, the potential customer can be left in an information void when he is confronted with an e-commerce site that is no longer available. The potential customer is often left wondering whether the company is still in business or whether it is merely encountering “technical difficulties”. Even under the latter scenario, the potential customer's confidence in the reliability of doing e-commerce with the merchant is often badly shaken. The novelty to a new e-commerce customer of doing business over the Internet is often accompanied, if not outweighed, by a significant degree of apprehension. The degree of apprehension experienced by potential customers is only increased through unreliable e-commerce sites. The unreliability associated with e-commerce prevalent in the industry today also adversely impacts an e-commerce business' goodwill.

The incorporation of a second or even redundant operating system on the flash memory chip (e.g., an operating system apart from that used in the base computer) may enable the e-commerce merchant to maintain certain core functions of his or her e-commerce site even in the event of a hard drive malfunction. To continue with the illustration, if the potential customer described above were to visit the e-commerce site of a merchant employing the preferred embodiments, he may still be able to access to merchant's Web page and the information contained therein. Even if the e-commerce such as the placing of orders and processing of payments electronically would not be possible, business at another level could be facilitated. For example, the potential customer would likely be able to find information about the merchant from its Web page and would likely be able to contact the merchant through an alternate means such as telephone, fax, e-mail or by going to the merchant's physical location. In contrast, in a system which does not have the redundancy of some of the preferred embodiments, commerce even at this reduced level could no longer be possible in the event of a hard drive malfunction.

To complete the illustration, the failure of a hard drive in a system which does not have the preferred embodiments may result in all e-commerce functions ceasing. This means that potential customers may not be able to reach the Web site or otherwise contact the merchant. The functional equivalent of such a failure from the perspective of a “brick and mortar” establishment would be to have the potential customer visit the merchant's place of business one day, inspect the article which he is considering, leave and return the next day only to find that the merchant, its building and its place of business are gone.

The remote administration modules of some of the preferred embodiments may allow for remote administration and configuration of the present invention. These software modules may enable the present invention's settings and functions to be set, adjusted and reset remotely. The software modules developed for the present invention may be the only ones of their kind which allow for remote administration of the present invention over the Internet using a remote device which may be using an operating system different from the present invention. The present invention may be designed to operate using the Linux operating system. But through the remote administration modules of the preferred embodiments, the present invention can be remotely configured from any computer located anywhere in the world. The remote computer may be running an operating system different from the present invention. All that is likely required is Internet access and a Web browser.

The remote administration feature may provide the user with considerable cost savings in installing and maintaining the present invention. In contrast, an e-commerce server using a conventional configuration usually must have a network administrator familiar with the technology employed and often physically present at the server to be configured. In all instances, such a level of support could be expensive and time-consuming. For many small- and medium-sized businesses such administration costs constitute a barrier entry so as to make e-commerce economically unfeasible. An advanced remote administration feature allows the disk on chip revised operating system to be updated from a remote location.

With the remote administration embodiments, the present invention can be configured or reconfigured by the vendor of the present invention or by anyone in the business of providing network administration services. All of this can be accomplished without having the network administrator present at the location to be configured. For those businesses that already have network administration personnel, the remote administration feature may enable the same number of administrators to configure and maintain ever-increasing numbers of servers and to do so without the costs associated with travel or having network administrators stationed at numerous locations. In these respects the remote administration embodiments of the present invention may represent a lowering or outright elimination of barriers to entry to the realm of e-commerce for many businesses. By also presenting an integrated (e.g., physically a part of the system) firewall element, a more thorough capability may also be provided.

As those skilled in the art may easily appreciate, the configurations and functions mentioned may be generated by software and so many of the various elements involved may actually be subroutines or other portions of software coding presented to an independent multipurpose programmable processor. Thus the interconnections shown or described should be understood as illustrative and for conceptual purposes only. They should not be viewed as limiting as pure hardwiring or mechanical interconnection may not be necessary. Regardless of the configuration, however, each element may be presented to the user through a great variety of embodiments.

Where the invention is described in functionally-oriented terminology, each aspect of the function can be accomplished by a device, person, subroutine, or program. Apparatus claims are included for some of the devices described. Method claims may also be included to address the functions the invention and each element performs. Neither the description nor the terminology is intended to limit the scope or degree of the claims which may be included as supported by this description.

Throughout this disclosure, it should be understood elements may be “responsive” to other elements. The broadest sense is intended. There may be intervening elements or translational components but in general all that is necessary is that the change or occurrence within one element achieves—either directly or indirectly—a change or occurrence within another element in order to be “responsive”.

As can be easily understood from the foregoing, the basic concepts of the present invention may be embodied in a variety of ways. It involves both electronic communication techniques as well as devices to accomplish the appropriate communications link. In this application, the communication techniques are disclosed as part of the results shown to be achieved by the various devices described and as steps which are inherent to utilization. They are simply the natural result of utilizing the devices as intended and described. In addition, while some devices are disclosed, it should be understood that these not only accomplish certain methods but also can be varied in a number of ways. Importantly, as to all of the foregoing, all of these facets should be understood to be encompassed by this disclosure.

The discussion included in this application is intended to serve as a basic description. The reader should be aware that the specific discussion may not explicitly describe all embodiments possible; many alternatives are implicit. It also may not fully explain the generic nature of the invention and may not explicitly show how each feature or element can actually be representative of a broader function or of a great variety of alternative or equivalent elements. Again, these are implicitly included in this disclosure.

It should also be understood that a variety of changes may be made without departing from the essence of the invention. Such changes are also implicitly included in the description. They still fall within the scope of this invention. A broad disclosure encompassing both the explicit embodiment(s) shown, the great variety of implicit alternative embodiments, and the broad methods or processes and the like are encompassed by this disclosure.

Further, each of the various elements of the invention and claims may also be achieved in a variety of manners. This disclosure should be understood to encompass each such variation, be it a variation of an embodiment of any apparatus embodiment, a method or process embodiment, or even merely a variation of any element of these. Particularly, it should be understood that as the disclosure relates to elements of the invention, the words for each element may be expressed by equivalent apparatus terms or method terms—even if only the function or result is the same. Such equivalent, broader, or even more generic terms should be considered to be encompassed in the description of each element or action. Such terms can be substituted where desired to make explicit the implicitly broad coverage to which this invention is entitled. As but one example, it should be understood that all actions may be expressed as a means for taking that action or as an element which causes that action. Similarly, each physical element disclosed should be understood to encompass a disclosure of the action which that physical element facilitates. Regarding this last aspect, as but one example, the disclosure of a “router element” or even a “router” should be understood to encompass disclosure of the act of “routing”—whether explicitly discussed or not—and, conversely, were there only disclosure of the act of “routing”, such a disclosure should be understood to encompass disclosure of a “router”, a “router element” and even a “means for routing” Such changes and alternative terms are to be understood to be explicitly included in the description. Naturally in the drawings well known components and systems should be understood as inherently included.

Any patents, publications, or other references mentioned in this application for patent are hereby incorporated by reference. In addition, as to each term used it should be understood that unless its utilization in this application is inconsistent with such interpretation, common dictionary definitions should be understood as incorporated for each term and all definitions, alternative terms, and synonyms such as contained in the Random House Webster's Unabridged Dictionary, second edition are hereby incorporated by reference.

Thus, the application should also be understood to support claiming, if desired, of not only those claims listed but also, at least: i) each of the configuration and operating system devices as herein disclosed and described, ii) the related methods disclosed and described, iii) similar, equivalent, and even implicit variations of each of these devices and methods, iv) those alternative designs which accomplish each of the functions shown as are disclosed and described, v) those alternative designs and methods which accomplish each of the functions shown as are implicit to accomplish that which is disclosed and described, vi) each feature, component, and step shown as separate and independent inventions, vii) the applications enhanced by the various systems or components disclosed, viii) the resulting products produced by such systems or components, ix) methods and apparatuses substantially as described hereinbefore and with reference to any of the accompanying examples, x) the various combinations and permutations of each of the elements disclosed, xi) processes performed with the aid of or on a computer as described throughout the above discussion, xii) a programmable apparatus as described throughout the above discussion, xiii) a computer readable memory encoded with data to direct a computer comprising means or elements which function as described throughout the above discussion, xiv) a computer or processor configured as herein disclosed and described, xv) individual or combined subroutines and programs as herein disclosed and described, xvi) the related methods disclosed and described, xvii) similar, equivalent, and even implicit variations of each of these systems and methods, xviii) those alternative designs which accomplish each of the functions shown as are disclosed and described, xix) those alternative designs and methods which accomplish each of the functions shown as are implicit to accomplish that which is disclosed and described, xx) each feature, component, and step shown as separate and independent inventions, and xxi) the various combinations and permutations of each of the above.

It should be noted that the term “at least one” as used in the description and claims is not intended nor used in this disclosure to mean that other claims or descriptions not incorporating the “at least one” language cannot further include one or more like elements. More specifically, the language “at least one” is not intended nor used to change “open-ended” claims, inherently including devices or methods having additional elements or steps apart from those claimed, into “closed-ended” claims wherein devices or methods having additional elements would not be covered by such claims. Accordingly, if or when used, the use of the transitional phrase “comprising” is used to maintain the “open-end” claims herein, according to traditional claim interpretation. Thus, unless the context requires otherwise, it should be understood that the term “comprise” or variations such as “comprises” or “comprising”, are intended to imply the inclusion of a stated element or step or group of elements or steps but not the exclusion of any other element or step or group of elements or steps. Such terms should be interpreted in their most expansive form so as to afford the applicant the broadest coverage legally permissible.

We claim:

1. A stand alone fault tolerant Internet communications system comprising:
a. an independent multipurpose programmable processor;
b. at least one independent memory element to which said independent multipurpose programmable processor is responsive;
c. at least one communications element which is responsive to said independent multipurpose programmable processor;
d. at least one router element which is responsive to said communications element; and
e. at least one independent data server element which is responsive to both said independent multipurpose programmable processor and said at least one independent memory element.

2. A stand alone fault tolerant Internet communications system as described in claim 1 and further comprising an independent operating system element to which said independent multipurpose programmable processor is responsive to at least some functionality.

3. A stand alone fault tolerant Internet communications system as described in claim 2 wherein said independent operating system element comprises a flash memory element.

4. A stand alone fault tolerant Internet communications system as described in claim 2 wherein said independent operating system element comprises a reduced functionality operating system element.

5. A stand alone fault tolerant Internet communications system as described in claim 1 and further comprising a remote administration element to which said independent multipurpose programmable processor is responsive.

6. A stand alone fault tolerant Internet communications system as described in claim 1 and further comprising a remote configuration element to which said independent multipurpose programmable processor is responsive.

7. A stand alone fault tolerant Internet communications system as described in claim 6 wherein said remote configuration element comprises a Web browser element.

8. A stand alone fault tolerant Internet communications system as described in claim 6 wherein said remote configuration element comprises a disparate operating system element.

9. A stand alone fault tolerant Internet communications system as described in claim 6 wherein said remote configuration element comprises a flash memory element.

10. A stand alone fault tolerant Internet communications system as described in claim 1 and further comprising a redundant operating system element to which said independent multipurpose programmable processor is responsive to at least some functionality.

11. A fault tolerant Internet communications system comprising:
a. a computer;
b. at least one communications element which is responsive to said computer;
c. at least one router element which is responsive to said communications element;
d. at least one data server element which is responsive to computer;
e. an integrated firewall element to which said communications element is responsive; and
f. an independent operating system element to which said computer is responsive to at least some functionality.

12. A fault tolerant Internet communications system as described in claim 11 wherein said independent operating system element comprises a flash memory element.

13. A fault tolerant Internet communications system as described in claim 11 wherein said independent operating system element comprises a reduced functionality operating system element.

14. A fault tolerant Internet communications system as described in claim 11 and further comprising a remote administration element to which said computer is responsive.

15. A fault tolerant Internet communications system as described in claim 11 and further comprising a remote configuration element to which said computer is responsive.

16. A fault tolerant Internet communications system as described in claim 15 wherein said remote configuration element comprises a Web browser element.

17. A fault tolerant Internet communications system as described in claim 15 wherein said remote configuration element comprises a disparate operating system element.

18. A fault tolerant Internet communications system as described in claim 11 and further comprising a redundant operating system element to which said computer is responsive to at least some functionality.

19. A fault tolerant Internet communications system comprising:
a. a computer;
b. at least one communications element which is responsive to said computer; and
c. a reduced functionality operating system element to which said computer is responsive.

20. A fault tolerant Internet communications system as described in claim 19 wherein said reduced functionality operating system element comprises a flash memory element.
